(19) United States
(12) Patent Application Publication
(10) Pub. No.: US 2009/0311644 A1
(43) Pub. Date: Dec. 17, 2009

(54) SOLUTION FOR TREATING LIME MUD

(75) Inventors: Juhani Isaksson, Tampere (FI); Kari Kuukkanen, Tampere (FI)

Correspondence Address: VENABLE LLP, P.O. BOX 34385, WASHINGTON, DC, 20043-9998, US

(73) Assignee: Metso Power Oy, Tampere (FI)

(21) Appl. No.: 12/484,441

(22) Filed: Jun. 15, 2009

(30) Foreign Application Priority Data
Jun. 13, 2008 (FI) 20085583

(51) Int. Cl. C04B 2/12; F27B 7/00; F27B 7/14; F27B 7/20; C10J 3/46

(52) U.S. Cl. 432/14; 432/108; 432/110; 432/119; 432/94

(57) ABSTRACT

A method for treating lime mud, in which method the lime mud is conveyed to a lime kiln, where fuel gas is used as fuel, which fuel gas is formed by a circulating fluidized bed gasifier. A calcium compound is used as bed material in the gasifier. In addition, the invention relates to the use of a calcium compound in a lime mud treatment plant, as well as to a lime mud treatment plant.

### CROSS-REFERENCE TO RELATED APPLICATIONS

This application claims priority under 35 USC §119 to Finnish Patent Application No. 20085583 filed on Jun. 13, 2008.

### FIELD OF THE INVENTION

The invention relates to a method for treating lime mud. In addition, the invention relates to the use of calcium compounds as bed material for a circulating fluidized bed gasifier of a lime mud treatment plant, as well as to a lime mud treatment plant.

### BACKGROUND OF THE INVENTION

Lime mud is calcium carbonate (CaCO₃) in a solid form. Lime mud is formed in the pulp manufacturing process in the manufacture of white liquor and it is separated from white liquor by filtering. A lime kiln, in turn, is an oven, where lime mud is burnt to calcium oxide, i.e. to burnt calcium (CaO) and carbon dioxide (CO₂), after which the calcium can be re-used in causticization.

Typically a lime kiln is a slightly tilted, horizontally rotating oven. The kiln is lined by bricks on the inside. The purpose of the lining is to decrease the heat losses of the kiln, as well as to protect the kiln from erosive chemicals. The kilns in use are 53 to 122 m in length and 2 to 4 m in diameter. Correspondingly, the capacity varies between 45 to 400 t CaO per day.

A conventional lime kiln can be divided into four different zones: The lime mud feed end comprises a drying zone, where the water contained by the lime mud is evaporated. Next is the heating zone, where the lime mud heats to the reaction temperature. After that is the reaction zone, where the calcium carbonate dissolves into calcium oxide and carbon dioxide. Last is the cooling zone, where the calcium is cooled before it is removed from the kiln.

The kiln comprises a burner, and by the temperature and size of its flame it is possible to affect, inter alia, the productions capacity of the kiln and the quality of the calcium. Oil or gas is generally used as fuel in the burners. In some solutions, a circulating fluidized bed gasifier, i.e. a CFB gasifier is used for gasifying bark or other biomass. The product gas formed in this replaces the natural gas or oil used as fuel in the lime kiln.

In known solutions, dolomite or sand is used as bed material in gasifiers. This bed material is ground and it flies partly all the way to the lime kiln, thus, for its part, causing fouling of lime mud and/or the end product. Similarly, a part of the ash of the fuel ends up in the lime kiln.

Because the thermal value of the product gas is small, a great amount of gas is needed for producing the necessary power.

### BRIEF SUMMARY OF THE INVENTION

Now a solution has been invented, by which the purity of the end product of a lime kiln, i.e. burnt calcium can be improved when product gas gasified from biomass or other fuel is used as fuel.

To achieve this aim, the method according to the invention lime mud is conveyed to a lime kiln, where fuel gas is used as fuel, which fuel gas is formed by a circulating fluidized bed gasifier wherein a calcium compound is used as bed material for the gasifier. The use of a calcium compound according to the invention, in turn, is primarily characterized in that the calcium compound is used as bed material for a circulating fluidized bed gasifier of a lime mud treatment plant. The lime mud treatment plant according to the invention is, in turn, primarily characterized in that the bed material of the gasifier is a calcium compound.

The basic idea of the invention is to use a calcium compound, such as calcium carbonate (CaCO₃), calcium oxide (CaO), calcium hydroxide (Ca(OH)₂) and/or lime mud as bed material for a circulating fluidized bed gasifier. Lime mud is taken from the chemical circulation of a pulp mill after causticization before lime kiln. The material ground from bed material is calcium oxide, i.e. it corresponds to burnt calcium (CaO), in which case the bed material conveyed to the lime kiln does not cause fouling of the end product and thus the capacity of the lime kiln can be increased, if necessary.

In an advantageous embodiment the lime mud is conveyed to the lime kiln, where fuel gas is used as fuel. Fuel gas is formed by a circulating fluidized bed gasifier, where a calcium compound is used as bed material.

In an embodiment fuel gas is formed in the gasifier from bio-based or other materials. Bio-based fuels include, e.g. bark, wood chips, sawdust, straw, different logging waste and other organic waste, etc. Other fuels suitable for gasification include, for example, peat and waste paper.

In an embodiment at least a part of the lime mud is fed to the gasifier. Thus, lime mud is calcinated partly or entirely and is conveyed with product gas to the lime kiln. Thus, fouling of burnt calcium (CaO) decreases and the capacity of the lime kiln can be increased by calcinating a part of the lime mud already in the gasifier.

The different embodiments of the invention can be used as various configurations and in different environments.

### DESCRIPTION OF THE DRAWINGS

In the following, the invention will be described in more detail with reference to the appended principle drawings, in which

FIG. 1 shows a lime mud treatment plant according to the invention

FIG. 2 shows another embodiment of a lime mud treatment plant

For the sake of clarity, the drawings only show the details necessary for understanding the invention. The structures and details that are not necessary for understanding the invention but are obvious for anyone skilled in the art have been omitted in the figures in order to emphasize the characteristics of the invention.

### DETAILED DESCRIPTION OF THE INVENTION

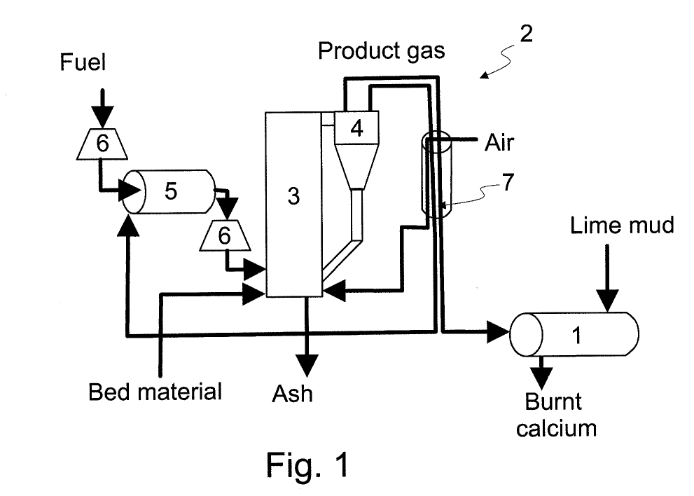

FIG. 1 shows only those parts of a lime mud treatment plant that are necessary for describing the invention. These include a lime kiln 1 and a gasifier unit 2. The gasifier unit 2 is a circulating fluidized bed gasifier, i.e. a CFB gasifier. The gasifier 2 comprises a process chamber 3, where air, fuel to be gasified and bed material are conveyed by suitable feeding structures. In the process chamber 3 the fuel is gasified into product gas. The gasifier unit 2 in addition comprises a separating unit 4, such as a cyclone, where bed material and ash are aimed to be separated from product gas. The separated bed material is circulated in the example back to the process chamber 3. Ash, in turn, is removed from the lower part of the gasifier. Product gas is conveyed from the gasifier 2 to the lime kiln 1. In practice, bed material and combustion residue is also conveyed to the lime kiln 1 with the product gas.

The gasification process is especially suitable for solid, bio-based fuels, such as bark, wood chips, sawdust, straw, different logging waste and other bio-based waste, etc. Other fuels, such as peat and waste paper, may also be used in gasification.

Calcium compound is used as bed material. The bed material fed to the gasifier unit 2 is fine-grained and at least a part of it is ground even finer in the gasifier. Fine bed material may be conveyed with the fuel gas being formed further to the lime kiln 1.

A conventional structure of a lime kiln 1 has already been described above. A lime kiln 1 comprises a burner, to which the product gas is conveyed from the gasifier. By the temperature and size of the flame of the burner it is possible to affect, inter alia, the production capacity of the kiln and the quality of the calcium. In addition, air and lime mud is conveyed to the lime kiln 1. Calcium and flue gases, in turn, exit the lime kiln 1. Typically flue gases are directed to a cleaning unit (not shown), such as, for example a flue gas scrubber.

By using a calcium compound as bed material in the gasifier 2, the amount of undesired material accumulating in the lime kiln 1 can be decreased. Burnt calcium is material produced in the lime kiln and the bed material ground in the gasifier and conveyed via the lime kiln 1 can therefore be utilized in the end product.

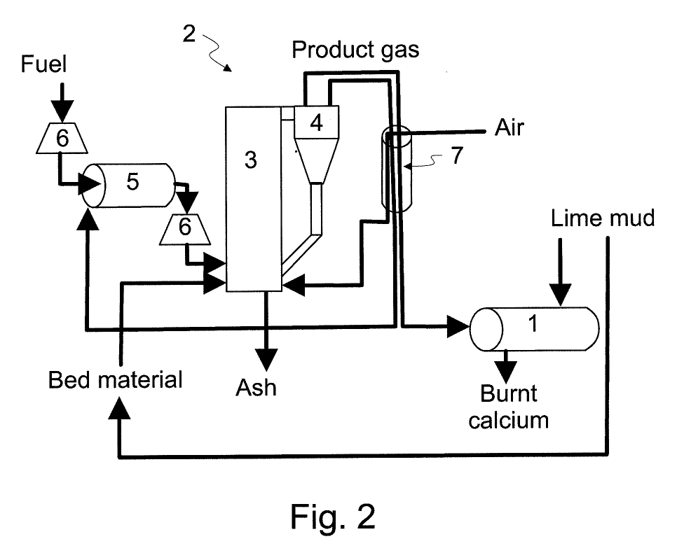

In the application of FIG. 2, at least a part of the lime mud is fed to the gasifier 2. The lime mud fed to the gasifier 2 advantageously operates as bed material. In an embodiment the entire bed material is formed of lime mud. In another application only a part of the bed material is formed of lime mud and the rest of the bed material is formed of some other suitable material, such as, for example, calcium carbonate, calcium oxide and/or calcium hydroxide. In the process chamber 3 of the gasifier 2 the lime mud is calcinated partly or entirely. The calcinated lime mud is conveyed with the product gas to the lime kiln 1. With this solution it is possible to increase the capacity of the lime mud treatment plant.

In addition, the lime mud treatment plant advantageously comprises a drying unit 5 for fuel and fuel intermediate storages 6, as well as combustion air preheating 7.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention may be freely varied within the scope of the inventive features presented in the claims hereinbelow.

1. A method for treating lime mud, in which method lime mud is conveyed to a lime kiln, where fuel gas is used as fuel, which fuel gas is formed by a circulating fluidized bed gasifier,wherein a calcium compound is used as bed material for the gasifier.

2. The method according to claim 1, wherein as bed material is used at least one of the following: calcium carbonate (CaCO₃), calcium oxide (CaO), calcium hydroxide (Ca(OH)₂), lime mud.

3. The method according to claim 1, wherein fuel gas is formed of a bio-based material in the gasifier.

4. The method according to claim 3, wherein fuel gas is formed in the gasifier from at least one of the following fuels: bark, wood chips, sawdust, straw, logging waste, peat, waste paper.

5. The method according to claim 1, wherein at least a part of the calcium compound is fed to the gasifier.

6. The use of a calcium compound as bed material for a circulating fluidized bed gasifier of a lime mud treatment plant.

7. The use according to claim 6, wherein as bed material is used at least one of the following: calcium carbonate (CaCO₃), calcium oxide (CaO), calcium hydroxide (Ca(OH)₂), lime mud.

8. A lime mud treatment plant, which comprises at least a lime kiln, and a gasifier for forming fuel gas, which gasifier is a circulating fluidized bed gasifier, wherein the bed material of the gasifier is a calcium compound.

9. The lime mud treatment plant according to claim 8, wherein as bed material is used at least one of the following: calcium carbonate (CaCO₃), calcium oxide (CaO), calcium hydroxide (Ca(OH)₂), lime mud.

10. The lime mud treatment plant according to claim 8, wherein the plant comprises means for feeding a calcium compound to the gasifier.

11. The lime mud treatment plant according to claim 8, wherein the plant comprises means for feeding a bio-based fuel to the gasifier.
